(19) United States
(12) Patent Application Publication
(10) Pub. No.: US 2009/0150773 A1
(43) Pub. Date: Jun. 11, 2009

(54) DYNAMIC PRODUCT CONFIGURATION USER INTERFACE

(75) Inventors: James H. Falkner, Altamonte Springs, FL (US); Manpreet Singh Oberoi, Palo Alto, CA (US)

Correspondence Address: BROOKS KUSHMAN P.C. / SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 11/950,440

(22) Filed: Dec. 5, 2007

(51) Int. Cl. G06F 3/00

(52) U.S. Cl. 715/700

(57) ABSTRACT

Configuration user interfaces are dynamically generated in different installation scenarios independently of the application logic being configured. Page definition files specify control properties. Description fragments, extracted from the page definition files, are merged at run time with page templates selected to match the interface type of the target computer. A user interface page is generated on the target computer user interface using one of a plurality of display engines appropriate for the target computer user interface type. User interface generation may be part of a wizard which passes user input to application logic for validation.

### BACKGROUND OF THE INVENTION

1. Field of the Invention

The present invention relates to generating user interfaces such as for use in software installation and configuration.

2. Background Art

Useful software is often written to work in a variety of environments, including different operating systems and hardware configurations. Typically, software is delivered to a user or system manager responsible for installing and configuring the software on one or more target machines. To assist in installation and configuration, a product configuration user interface that interacts with the user through the target computer user interface is often provided.

Product configuration user interfaces typically present a wide variety of installation and configuration choices. Because of the wide variety of target machines and applications, configuration user interfaces may have to provide graphic user interfaces and text-based interfaces for a number of platforms. In addition, automated configuration interfaces may also be necessary for group or other unassisted installations.

Software programmers responsible for configuration interfaces face a problem in designing and maintaining many different interfaces for many target systems for the same product. This not only requires a great deal of effort, but may result in errors while attempting to bring each variation into conformity with design changes and version updates. One specific problem faced by software programmers results from differing installation mechanisms not providing functional parity. Another problem is that inputted values are not always validated for correctness in each version. In addition, it is difficult to globally change the look an feel of the interface.

### SUMMARY OF THE INVENTION

The present invention provides for dynamically generating configuration user interfaces in different installation scenarios.

In one embodiment of the present invention, a system for dynamically generating a configuration interface at run time on a target computer with a particular interface type is provided. The system includes a plurality of view definition files, each specifying at least one user interface control independent of information relating to any user interface type. A format converter converts each of the view definition files to at least one description fragment describing at least one interface control property. A template engine generates a merged page at run time by merging description fragment(s) with one of a plurality of page templates selected based on the particular interface type of the target computer. The system also supports different generator engines corresponding to each type of user interface. Each generator engine can display the information contained in the merged page if the generator engine interface type matches the interface type of the page template used to generate the merged page. Various types of user interfaces are supported, including common GUI and text-based interfaces.

Control logic may be provided to control flow through the sequence of page definition files. The flow may be further controlled based on input provided by a user through the user interface. The flow may also be controlled by a non-interactive script. Control logic may also verify user input using application logic that is independent of the view definition files and the page templates.

A method of generating a user interface at run time on a target computer system is also provided. For each of a plurality of page definition files, at least one description fragment specifying at least one interface control property is extracted. Each description fragment is merged with a page template selected for use based on the target computer user interface type. A user interface page is generated and displayed on the target computer user interface by one of a plurality of display engines appropriate for the target computer user interface type.

The above features, and other features and advantages of the present invention are readily apparent from the following detailed descriptions thereof when taken in connection with the accompanying drawings.

### BRIEF DESCRIPTION OF THE DRAWINGS

FIG. 1 is a block diagram illustrating an architecture for dynamic product configuration according to an embodiment of the present invention;

FIG. 2 is schematic diagram of a page sequence file according to an embodiment of the present invention;

FIG. 3 is a schematic diagram of an abstracted view definition file according to an embodiment of the present invention;

FIG. 4 is a schematic diagram illustrating page objects according to an embodiment of the present invention;

FIG. 5 is a schematic diagram illustrating interface page layout according to an embodiment of the present invention; and

FIG. 6 is a flow diagram illustrating user interface generation according to an embodiment of the present invention.

### DETAILED DESCRIPTION OF THE PREFERRED EMBODIMENT(S)

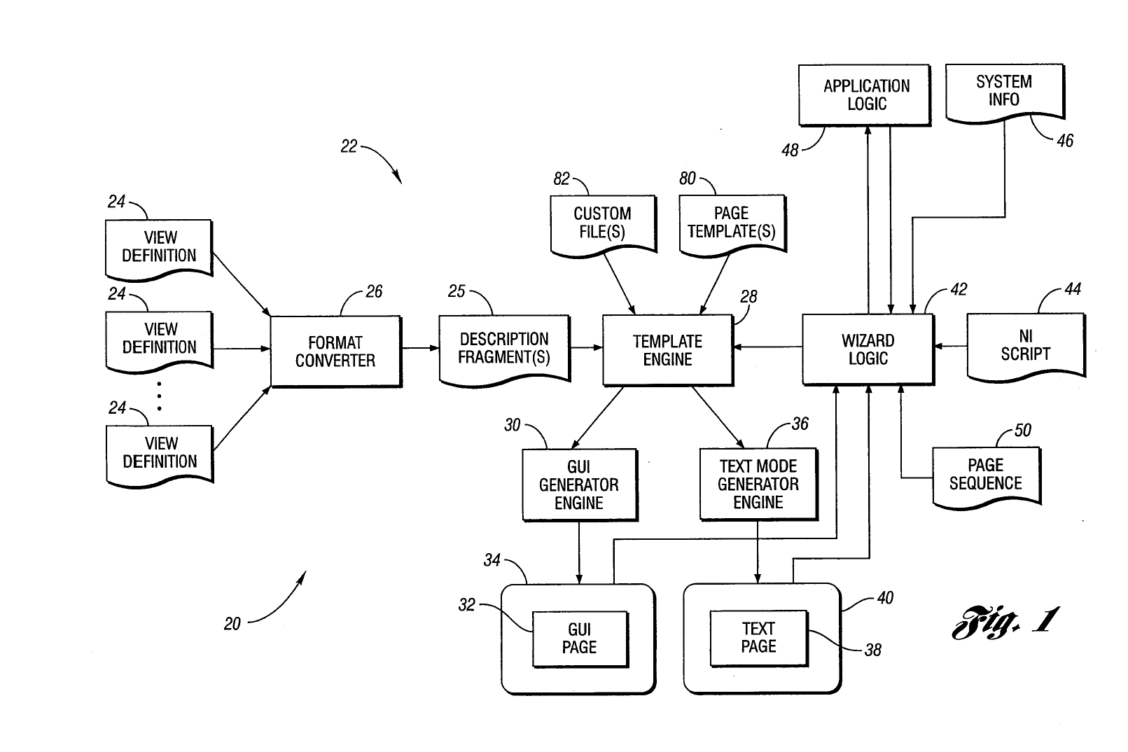

Referring to FIG. 1, a block diagram illustrating an architecture for dynamic product configuration according to an embodiment of the present invention is shown. A user interface (UI) generator, shown generally by 20, distinguishes display issues from data validation and other business logic. This separates view issues from model and controller issues in the Model View Controller (MVC) pattern such as can be found, for example, in openInstaller, an open source project building an installer framework.

UI generator 20 includes a wizard component, shown generally by 22, which sends and receives requests from and to other service provider components and to the core engine, not shown for clarity. Wizard component 22 acts as the main application thread for installation as interaction with the user occurs through wizard component 22. UI generator 20 is capable of providing one or more of a plurality of interactive styles, including graphical user interface (GUI) mode, text-based user interface mode, non-interactive (NI) mode, and the like. UI information is provided in configuration variable requirements described in view definition files 24. When a user interface is needed, view definition files 24 are converted in simple web forms, such as display fragments 25, such as XML-based UI description fragments, by format converter 26. These fragments are assembled into full page definitions by template engine 28, which dynamically tweaks the view mode independent features for the specific view mode. A view mode specific renderer then interprets the view definitions for the appropriate interface. For example, GUI generator engine 30 outputs display objects for creating GUI page 32 on graphical user interface 34. As another example, text mode generator engine 36 outputs text characters for creating text-based page 38 on text-based interface or CUI (composite user interface) 40.

Wizard logic 42 controls the flow which guides the user through installation steps by presenting pages 32, 34 to the user and accepting input from the user. Input may be provided by user interface 34, 40 through a variety of input types such as, for example, pointing device input, text entry, voice commands, and the like. In non-interactive mode, wizard logic replaces or supplements user input with input from NI script 44. Wizard logic 42 selects the appropriate interface type (e.g., GUI, CUI, non-interactive) based on system information 46 held by the target computer on which the interface is generated and for which configuration is desired. In addition to specifying interface type, system information 46 may include licensing information, user preferences, operating system information, security information, information on other application programs loaded on the target system, and the like. Typically, input is verified by sending validation requests to, and receiving validation responses from, application logic 48. Application logic 48 also holds, and later uses, configuration input data.

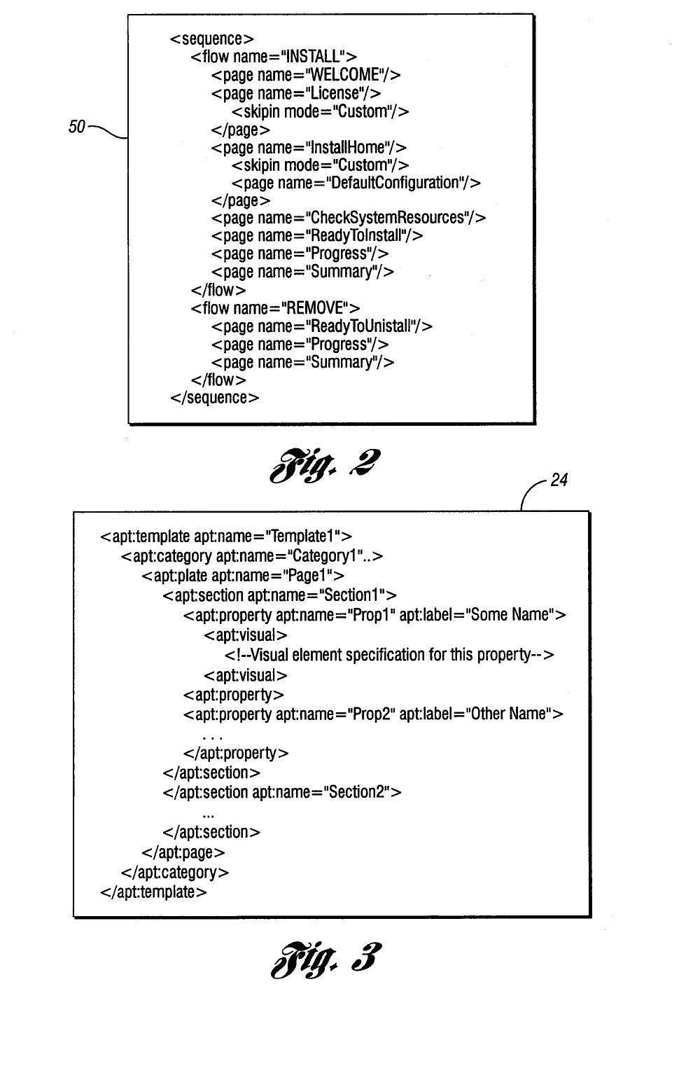

Referring as well to FIG. 2, a page sequence file according to an embodiment of the present invention is shown. Wizard logic 42 establishes the page flow by reading page sequence file 50 (e.g., pagesequence.xml) at startup and building an internal page list. An index into this list is maintained by wizard logic 42 as wizard logic 42 executes. Wizard logic 42 flips through the pages as specified in page sequence file 50 as a user fills in data on interface pages 32, 38, presses the back or next buttons, or the like. For example, on each clicking of the next button, wizard logic 42 sends specific data entered by the user to application logic 48 and requests validation. If the validation succeeds, wizard logic 42 proceeds to the next page in the sequence. Otherwise, wizard logic 42 provides an indication of the problem such as, for example, highlighting the data input field in interface page 32, 38 with the error, displaying a dialog box showing the results of failed validation and asking for correction, terminating operation, and the like. In the embodiment shown in FIG. 2, the “skipin” tag may be used to define arbitrary flows marked by other tags. Other program flow modification may be used, as is known in the art. For example, “when” conditional tags may also be used.

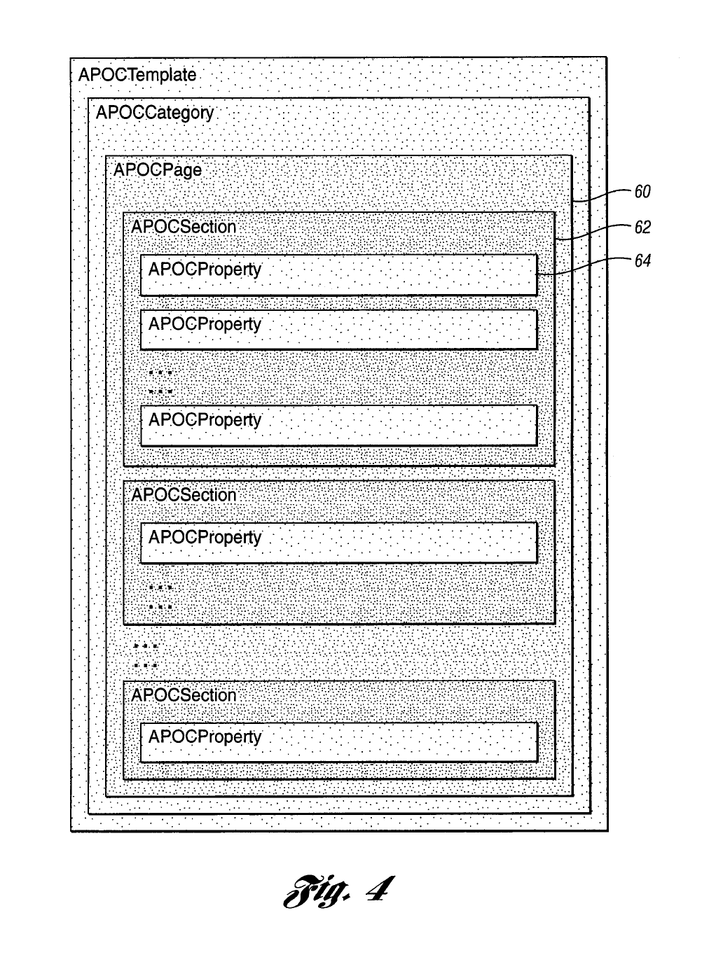

Referring as well to FIG. 3, an abstracted view definition file according to an embodiment of the present invention is shown. View definition file 24 is based on a UI Configuration View Definition (UCVD) template format. This format is based on the APOC (A Point Of Control) template. APOC is a management application developed for use in Java Desktop System software by Sun Microsystems, Inc. In the embodiment shown, view definition file 24 is a UCVD XML file defining a root element called <apt:template > whose “name” attribute is used to specify a value that uniquely identifies the template and matches the name of the XML file.

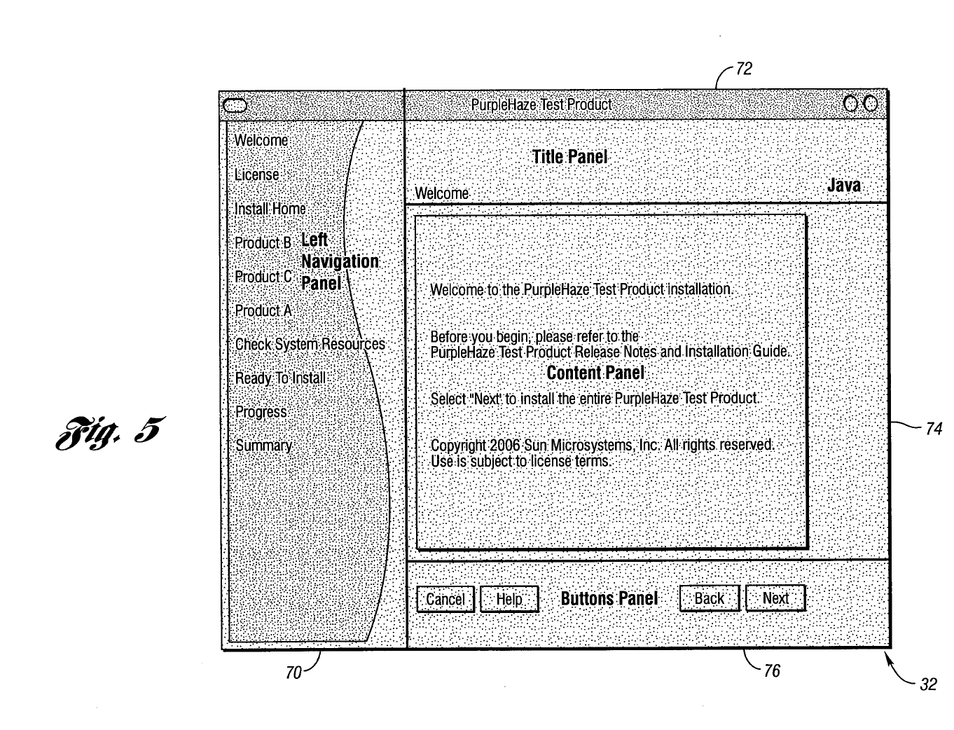

Referring again to FIG. 1, format converter 26 converts each view definition file 24 into display fragments 25 such as, for example, SwiX^{ml} fragments, that can be operated on by template engine 28. An object hierarchy is illustrated in FIG. 4. Each UCVD page is converted to page object 60, which maps to a single viewable page in a user interface content panel. Each section maps to a corresponding section object 62. If the UCVD page contains only a single section, then the content panel displays the properties inside section object 62 as visual elements directly in the content panel. If the UCVD page contains converts to more than one section object 62, each section object 62 is displayed as a “tab” in a “tabbed pane” inside the content panel. Each section object 62 includes one or more property object 64 which becomes a single UI element such as, for example, a text field, check box, and the like. In one embodiment, section objects 62 are expressed as fragments of SwiX^{ml}, as described in greater detail below.

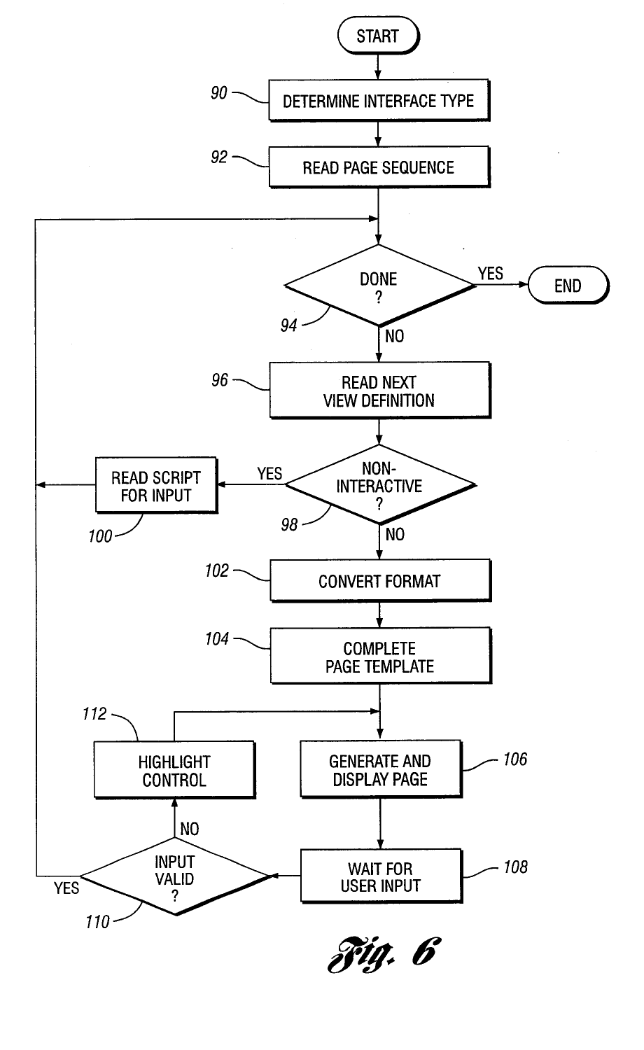

Each interface page 32, 38 may be divided into four panels, as illustrated for a graphical page in FIG. 5. Left navigation panel 70 displays the sequenced list of pages that are part of the current flow along with an indication of the user's current position within the navigational flow. Title panel 72 displays general information such as, for example, title of the page, company logo, product name, and the like. Content panel 74 displays the actual content that is dynamically generated from view definition file 24. Button panel 76 displays the buttons used for page navigation such as, for example, back, next, cancel, exit, help, and the like.

A wide variety of control types may be implemented within control panel 74. These include radio buttons for single select boolean input, check boxes for multi-select boolean input, text fields for single string data type input, lists for single or multi-select string predefined inputs, combo boxes for single selection from a predefined set or entry of new string input, password fields for password data type, text areas for multi-line text input, text panels for read only text display, HTML panels for read only HTML display, progress bars for progress display, directory selection as a special case of text field with a directory dialog popup button, integer range selection using a text field with an increment/decrement control, graphics containers, tooltips, and the like.

Position of controls within content panel 74 may be accomplished using a layout algorithm such as the following:

```
for each template; do
  for each category tree (combine all category specs to form one); do
    for each page; do
      create a new tab group
      for each section; do
        create new tab
        for each property; do
          add property's display representation to tab
        done
        add horizontal separator to tab
      done
      add tab group to config page
    done
  done
done
```

For any interface mode supported, a standard look and feel guideline may be adopted. For example, Java design guidelines may be adopted for the look and feel of GUI page 32. In addition, the layout algorithm may include placement rules and recommendations including one or more of the following:
1) Assume a row/column layout.
2) Assume that one component takes one row of space.
3) Reserve the first column for displaying labels if the page contains any component which must display a label. Provide a minimum width available to the first column to avoid the layout giving a jumping effect on page flips.
4) Use a GridBagLayout scheme or similar layout scheme with each component aligned northwest in its cell.
5) Use provided constants as cell spacing for layout.
6) Use constants (e.g., LABEL_FONT_NAME) to get component font and other similar information.
7) Build in a default or fallback mechanism for each constant that can be used.
8) Allow text fields to span the full width of the second column. Align these text fields at left and right.

As will be recognized by one of ordinary skill in the art, many different page layouts are within the scope of the present invention. The layout illustrated in FIG. 5 is provided merely as an illustrative example. Many variations are possible including other numbers and positions for panels, other layout algorithms, other control types, and the like.

Referring again to FIG. 1, template engine 28 generates text output based on description fragment(s) 25 and page template(s) 80. Template engine 28 may be, for example, FreeMarker, an OSI Certified Open Source Software product available with a BSD-style license from Visigoth Software Society. FreeMarker is a Java package including a class library. FreeMarker was designed to be used for generating HTML Web pages, particularly by servlet-based applications following the MVC pattern. The MVC pattern supports separation between basic design and programming for web pages. For example, the appearance of a page can be changed without having to change or recompile code because application logic 48 is separate from the page design and rendering process. This helps to keep interface design from becoming overburdened with complex program fragments and frees the design of application logic 48 from user interface details.

Template engine 28 may accept template file(s) 80 and/or custom file(s) 82 as well as interface object(s) 25 output from format converter 26. Each template file 80 defines the overall look of a generated interface page 32, 38. The data input fields and their type defined by view definition files 24 are converted into UI elements to be fitted into content area 74 of interface page 32, 38. The page template 80 defines navigation elements, such as back button, next button, and the like, and status indication elements, such as left status indicator bar 70. As with view definition pages, template files 80 can have custom versions such as, for example, for use with different interface types, operating systems, languages, and the like. Custom files 82 include GUI, CUI, and common properties file(s) for providing extended properties for GUI view mode, CUI view mode, and common properties. Extended properties can include one or more of custom UI components, custom configuration types, and the like. An example is a slide show custom control which provides marketing, instructional, or other information in successive slides while a user waits during an installation or other configuration. Internationalization, such as language choice for text, can also be provided in custom files 82. Characteristics, such as background images for panels, font properties, border properties, color properties, and the like, can also be specified in custom files 82.

Template engine 28 may operate by dynamically substituting text for the actual interface type used (e.g., GUI user interface 34 or CUI interface 40) and desired interface characteristics into special placeholder text in the page definition template. For the example of SwiX^{ml}, dynamic placeholder variables start with “${” and ends with “}”. Thus, a line in the page template that looked like <frame name=“frame1” title=“${PRODUCT_NAME}“> would have the variable ${PRODUCT_NAME} replaced with the actual product name in, for example, the desired language for the particular configuration interface.

GUI generating engine 30 generates graphical user interface pages 32 for display by graphical user interface 34. GUI generating engine 30 may be, for example, SwiX^{ml}, a GUI generating engine for Java applications and applets. SwiX^{ml} parses the XML output from template engine 28 at run time and renders this output into javax.swing objects. SwiX^{ml} allows late binding of the GUI, which enables the features in an application based on a license or a user's role to be free from hard coding. Instead, an XML document describing the GUI may be dynamically loaded. Thus, generating the GUI based on descriptors has advantages that code generators provide without generating non-maintainable code. SwiX^{ml} is an open source Java library that is freely available under a license from the Apache Software Foundation.

Text mode generating engine 36 generates text-based interface pages 38 for display by CUI user interface 40. Text mode generating engine 36 may be based on, for example, the Charva toolkit, a Java framework for presenting a user interface composed of elements such as windows, dialogs, menus, text fields, buttons, and the like, on a character-cell ASCII terminal. Charva provides an API based on swing. Charva is freely available under a GNU Lesser General Public License.

Referring now to FIG. 6, a flow diagram illustrating user interface generation according to an embodiment of the present invention is shown. As will be appreciated by one of ordinary skill in the art, the operations illustrated are not necessarily sequential operations. The order of steps may be modified within the spirit and scope of the present invention and the order shown here is for logical presentation. Also, methods illustrated may be implemented by any combination of hardware, software, firmware, and the like, at one location or distributed. In one embodiment, the method is implemented as wizard-based software held on a computer readable medium for execution on a target computer for application software configuration. The present invention transcends any particular implementation and the embodiments are shown in sequential flow chart form merely for ease of illustration. Moreover, the present invention need not include every operation provided in the particular embodiment shown.

An interface type is determined, as in block 90. Interface types may be one of a graphical type, a text-based type, or a non-interactive type. Various forms of each type are possible. For example, graphical types may include support for various versions of Microsoft Windows, GNU/Linux, Sun Solaris, Mac OS X, FreeBSD, and the like. The page sequence is read, as in block 92. The page sequence specifies the order or flow of view definition files and, hence, interface pages. This flow may include branches based on user selections and validation results. A check for done is made, as in block 94, based on the page sequence.

The next view definition file is read, as in block 96. A check is made to determine if the interface type is non-interactive, as in block 98. If so, a script may be accessed for any required or optional input, as in block 100. Flow then returns to the completion check of block 94. In this embodiment, no validation is performed on script input. However, as will be readily recognized by one of ordinary skill in the art, validation may be included as described below for interactive pages. Moreover, while non-interactive execution has been illustrated without displaying interface pages, non-interactive execution may also be carried out together with displayed interface pages.

If pages are to be displayed, the format of input definition files may be converted, as in block 102. View definition files may be entered by a developer in a format convenient to the developer. These view definition files may be converted to description fragments describing various control properties such as, for example, control type, control label, control grouping, and the like. A page template is completed using one or more description fragments, as in block 104. A page template is selected based on the interface type used in the target computer. Final data values are substituted for place holder values at run time, allowing view definitions to be adapted for the GUI or CUI environment actually implemented by the target system. Each interface page is generated and displayed, as in block 106, from the corresponding merged page template.

If needed, user input is obtained, as in block 108. A check is made to determine if this input is valid, as in block 110. If so, the check for done of block 94 is again made. If not, the control holding invalid input data is highlighted, as in block 112. This page is then displayed again and user input is again obtained. As will be appreciated by one or ordinary skill in the art, other techniques may be used to notify the user of erroneous input and/or to obtain further user actions. For example, a pop-up window may be displayed with special instructions. For some types of input, such as login and password data, freeze out may be used after a set number of unsuccessful attempts. Preferably, validation is accomplished by application logic outside of the interface generation system. This allows for separation of command and modeling coding from user interface definition.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for dynamically generating a configuration interface at run time on a target computer having a particular interface type, the particular interface type one of a plurality of different user interface types, the system comprising:
a plurality of view definition files, each view definition file specifying at least one user interface control independent of information relating to any of the plurality of different user interface types;
a format converter operative to convert each of the plurality of view definition files to at least one description fragment describing at least one interface control property;
a template engine in communication with the format converter, the template engine generating a merged page by merging at run time the at least one description fragment with one of a plurality of page templates selected based on the particular interface type of the target computer; and
at least one of a plurality of generator engines in communication with the template engine, each generator engine corresponding to a particular one of the plurality of different user interface types, each generator engine operative to display the information contained in the merged page if the generator engine interface type matches the interface type of the page template used to generate the merged page.

2. The system of claim 1 further comprising control logic operative to control flow through the sequence of page definition files based on a page sequence.

3. The system of claim 2 wherein the flow is further controlled based on input provided by a user providing input to the user interface.

4. The system of claim 2 wherein the flow is further controlled based on a non-interactive script.

5. The system of claim 1 further comprising control logic operative to verify user input using application logic, wherein the application logic is independent of the plurality of view definition files.

6. The system of claim 1 wherein the plurality of different user interface types comprises at least one graphical user interface type and at least one text-based user interface type.

7. A method of generating a user interface at run time on a target computer system supporting one of a plurality of user interface types, the method comprising:
for each of a plurality of page definition files, extracting at least one description fragment at run time from each of the page definition files, each description fragment specifying at least one interface control property;
merging at run time the at least one description fragment with a page template selected for use based on the target computer user interface type;
determining one of a plurality of display engines at run time based on the target computer user interface type; and
generating a user interface page at run time on the target computer user interface using the determined display engine.

8. The method of claim 7 further comprising determining a flow for processing the plurality of page definition files based on a page sequence file.

9. The method of claim 8 wherein the flow is further based on input received from a user of the target computer system.

10. The method of claim 8 wherein the flow is further based on a non-interactive script file.

11. The method of claim 7 further comprising accepting input from a user of the target computer system and validating the input using application logic which is independent from the plurality of page definition files and the selected page template.

12. The method of claim 7 wherein the plurality of user interface types includes at least one graphical user interface and at least one text-based user interface.

13. A computer readable storage medium containing instructions for execution on a computer to generate a user interface at run time on the computer supporting one of a plurality of user interface types, the computer readable storage medium comprising:
for each of a plurality of page definition files, computer code for extracting at least one description fragment at run time from each of the page definition files, each description fragment specifying at least one interface control property;
computer code for merging at run time the at least one description fragment with a page template selected for use based on the target computer user interface type;
computer code for determining one of a plurality of display engines at run time based on the target computer user interface type; and
computer code for generating a user interface page at run time on the target computer user interface using the determined display engine.

14. The computer readable storage medium of claim 13 further comprising computer code for determining a flow for processing the plurality of page definition files based on a page sequence file.

15. The computer readable storage medium of claim 14 wherein the flow is further based on input received from a user of the target computer system.

16. The computer readable storage medium of claim 14 wherein the flow is further based on a non-interactive script file.

17. The computer readable storage medium of claim 13 further comprising computer code for accepting input from a user of the target computer system and validating the input using application logic which is independent from the plurality of page definition files and the selected page template.

18. The computer readable storage medium of claim 13 wherein the plurality of user interface types includes at least one graphical user interface and at least one text-based user interface.
